(19) United States
(12) Patent Application Publication
(10) Pub. No.: US 2016/0214218 A1
(43) Pub. Date: Jul. 28, 2016

(54) HUB NUT CAULKING DEVICE AND METHOD

(71) Applicant: HYUNDAI MOBIS CO., LTD., Seoul (KR)

(72) Inventor: Bong Kyu KIM, Seoul (KR)

(21) Appl. No.: 14/993,677

(22) Filed: Jan. 12, 2016

(30) Foreign Application Priority Data
Jan. 26, 2015 (KR) 10-2015-0012135

(51) Int. Cl. B23P 19/06; B21D 53/24; B60B 27/06

(52) U.S. Cl. CPC B23P 19/063; B60B 27/065; B21D 53/24; B60B 2310/3142

(57) ABSTRACT

A hub nut caulking device may include: a housing member; a caulking member including a plurality of caulking parts which are rotatably coupled to the housing member and rotated to pressurize and caulk the hub nut; and a driving member coupled to the housing member so as to rotate the caulking parts.

### CROSS-REFERENCES TO RELATED APPLICATIONS

The present application claims priority to Korean application number 10-2015-0012135, filed on Jan. 26, 2015, which is incorporated by reference in its entirety.

### BACKGROUND

The present disclosure relates to a hub nut caulking device and method, and more particularly, to a hub nut caulking device and method capable of caulking a hub nut to a drive shaft.

In general, power generated from an engine of a vehicle is transferred to a drive shaft through a transmission, and the power transferred to the drive shaft is transferred to a driving wheel through a wheel disk and a hub coupled to an end of the drive shaft. The drive shaft and the hub are coupled to each other through a hub nut. Thus, the hub nut is assembled while manufacturing an automobile.

The related technology is disclosed in Korean Patent No. 10-0889668 published on Mar. 12, 2009, and entitled “Automatic caulking device of lock-nut”.

### SUMMARY

Embodiments of the present invention are directed to a hub nut caulking device and method which is capable of performing a caulking operation at a plurality of positions, easily managing an operation history related to the caulking operation, and controlling an operation of a device through wireless communication.

In one embodiment, a hub nut caulking device may include: a housing member; a caulking member including a plurality of caulking parts which are rotatably coupled to the housing member and rotated to pressurize and caulk the hub nut; and a driving member coupled to the housing member so as to rotate the caulking parts.

The housing member may include: a housing part to which the caulking part is rotatably coupled; and a caulking guide part coupled to an end of the housing part, and contacted with the hub nut so as to adjust the position of the housing part.

The housing member may further include a swivel part for rotatably supporting the housing part.

The swivel part may include: a housing coupling part coupled to the housing part; and a swivel to which the housing coupling part is rotatably coupled and which is coupled to a support wire to rotatably support the housing part.

The swivel may be formed in a ring shape, rotatably coupled to the housing coupling part, and coupled to the support wire through a wire connection ring coupled to the outer circumferential surface thereof.

The driving member may include: a piston rod part installed to reciprocate in the housing part; a rod driving part coupled to the housing part, and moving the piston rod part using hydraulic pressure; and a wedge part coupled to an end of the piston rod part, inserted between the pair of caulking parts according to the movement of the piston rod part, and rotating the caulking part.

The wedge part may have a cross-sectional area that gradually narrows toward the leading end which is inserted between the caulking parts. As the distance by which the wedge part is inserted between the caulking parts is increased, the extent that the caulking parts are rotated may be increased.

The rod driving part may include: a fluid inlet pipe coupled to the housing member and connected to a fluid storage part so as to receive fluid; and a control valve for controlling entry and exit of fluid through the fluid inlet pipe.

The hub nut caulking device may further include an output member coupled to the housing member and outputting a source or light signal according to the specification of the hub nut or the operation state of the driving member.

The output member may include: a movement measurement unit installed on the housing member or the caulking member, and measuring whether the piston rod part was moved a predetermined distance or more;

and an output unit outputting the information on whether the piston rod part was moved the predetermined distance or more.

The movement measurement unit may include: a magnetic force generation unit coupled to the piston rod part and generating a magnetic force; and a magnetic force measurement unit coupled to the housing member, and measuring the magnetic force generated from the magnetic force generation unit so as to determine whether the piston rod part was moved the predetermined distance or more.

The output member may further include an output terminal for transmitting the information on whether the piston rod part was moved the predetermined distance or more, to a main controller.

In another embodiment, a hub nut caulking method may include: moving a housing part to press a caulking guide part against a drive shaft or a hub nut, the caulking guide part being coupled to the housing part and contacted with the drive shaft or hub nut so as to adjust the position of the housing part; and operating a driving member coupled to the housing part, and rotating a plurality of caulking parts rotatably coupled to the housing part such that the hub nut is caulked to the drive shaft.

The hub nut caulking method may further include outputting information indicating that the caulking guide part is seated, through an output member coupled to the housing part, when the caulking guide part is pressed against the drive shaft or the hub nut.

The driving member may include a piston rod part installed to reciprocate in the housing part, a rod driving part coupled to the housing part and moving the piston rod part using hydraulic pressure, and a wedge part coupled to an end of the piston rod part, inserted between the pair of caulking parts according to the movement of the piston rod part, and rotating the caulking parts. The output member may include a magnetic force generation unit coupled to the piston rod part and a magnetic force measurement unit coupled to the housing member, determines whether the piston rod part was a predetermined distance or more, and transmits the determination result to a main controller.

### BRIEF DESCRIPTION OF THE DRAWINGS

FIG. 1 is a schematic perspective view of a hub nut caulking device in accordance with an embodiment of the present invention.

FIG. 2 is a front view of the hub nut caulking device in accordance with the embodiment of the present invention.

FIG. 3 is a plan view of the hub nut caulking device in accordance with the embodiment of the present invention.

FIG. 4 is a right side view of the hub nut caulking device in accordance with the embodiment of the present invention.

FIG. 5 is a left side view of the hub nut caulking device in accordance with the embodiment of the present invention.

FIG. 6 is a cross-sectional view illustrating a state in which caulking parts are spread in the hub nut caulking device in accordance with the embodiment of the present invention.

FIG. 7 is a schematic cross-sectional view of the caulking member and the driving member in FIG. 6.

FIG. 8 is a cross-sectional view illustrating a state in which the gap between the caulking parts is narrowed in the hub nut caulking device in accordance with the embodiment of the present invention.

FIG. 9 is a schematic cross-sectional view of the caulking member and the driving ember in FIG. 8.

FIG. 10 is a diagram illustrating a state in which the hub nut is caulked by the hub nut caulking device in accordance with the embodiment of the present invention.

FIG. 11 is a diagram illustrating the main controller in the hub nut caulking device in accordance with the embodiment of the present invention.

FIG. 12 is a conceptual view illustrating the main controller and a manufacturing execution system (MES) in the hub nut caulking device in accordance with the embodiment of the present invention.

FIG. 13 is a flowchart illustrating a hub nut caulking method in accordance with an embodiment of the present invention.

### DESCRIPTION OF EMBODIMENTS

Embodiments of the invention will hereinafter be described in detail with reference to the accompanying drawings. It should be noted that the drawings are not to precise scale and may be exaggerated in thickness of lines or sizes of components for descriptive convenience and clarity only.

Furthermore, the terms as used herein are defined by taking functions of the invention into account and can be changed according to the custom or intention of users or operators. Therefore, definition of the terms should be made according to the overall disclosures set forth herein.

In an automobile, a drive shaft and a hub are coupled to each other through a hub nut. To inhibit the components from disassembling after the hub nut is coupled to the drive shaft, a caulking operation is performed. More specifically, after the hub nut is coupled to the drive shaft, a part of the hub nut is pressurized and deformed and then caulked to a shaft groove formed at the end of the drive shaft.

In some instances, a hub nut caulking device may include only a single caulking part. Thus, when a plurality of caulking operations are applied, an excessive process time may be required, and the fatigue of an operator may be increased. Furthermore, when a plurality of caulking devices are used to assemble plural types of vehicles and plural types of specifications, errors or defects in assembling may occur to make it difficult to manage an operation history.

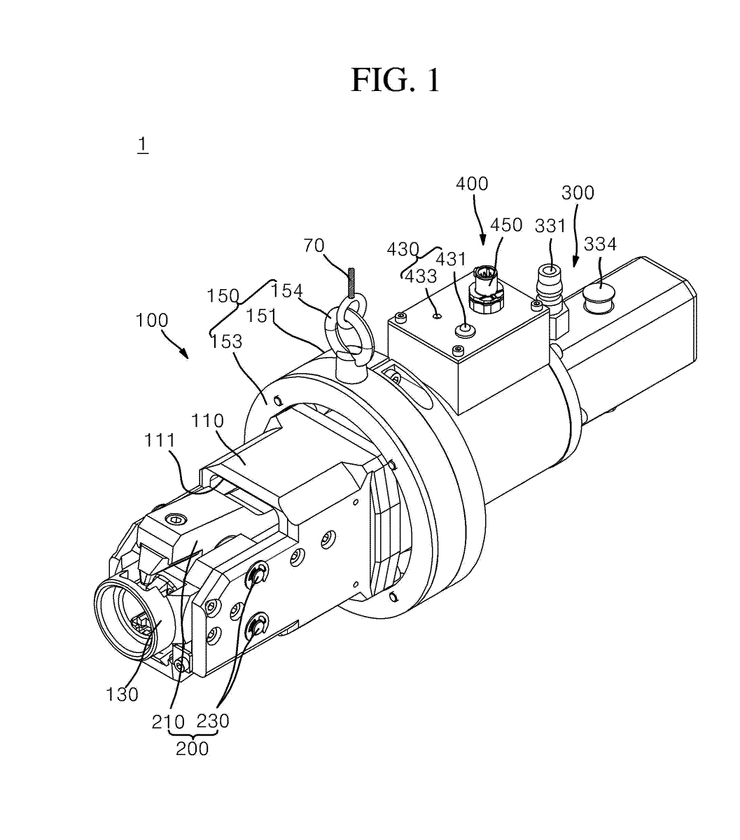

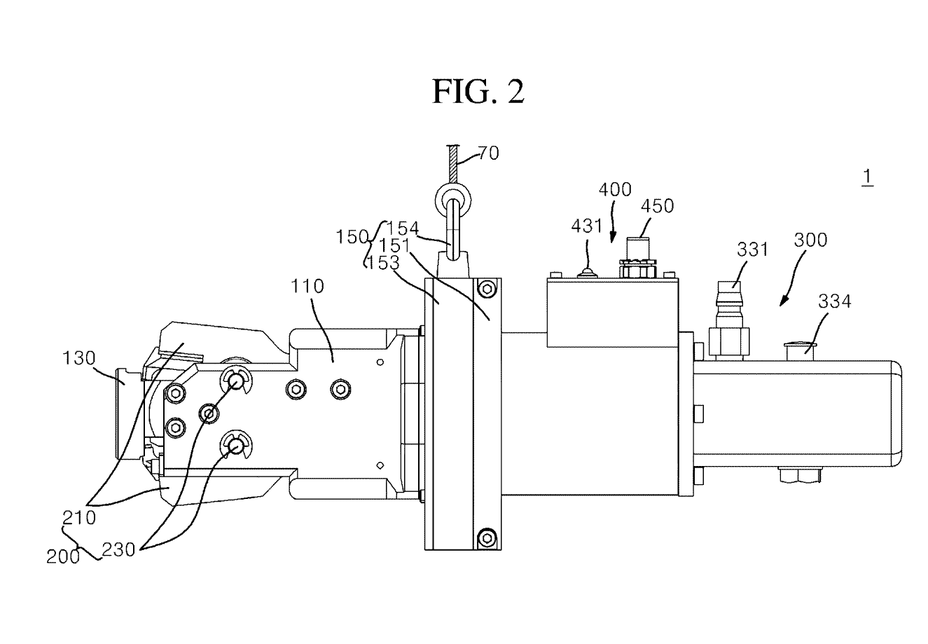

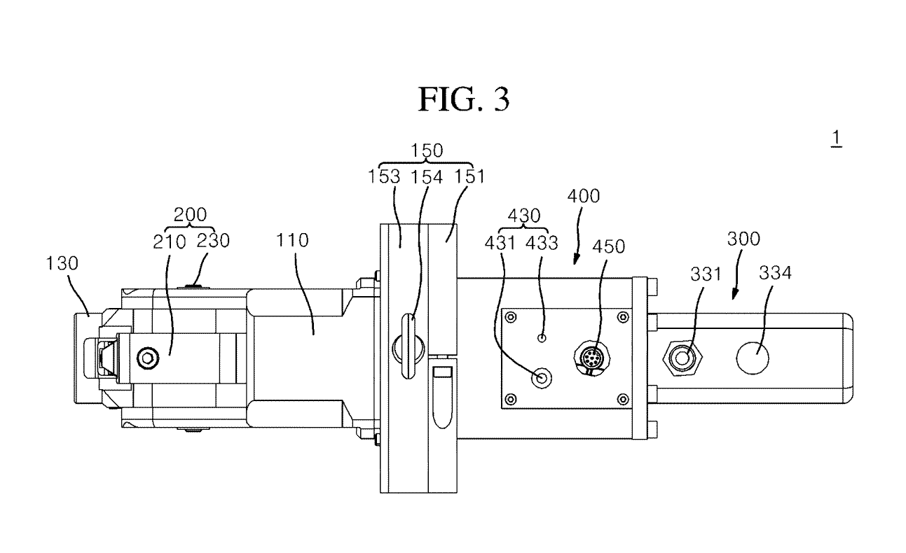

FIG. 1 is a schematic perspective view of a hub nut caulking device in accordance with an embodiment of the present invention. FIG. 2 is a front view of the hub nut caulking device in accordance with the embodiment of the present invention. FIG. 3 is a plan view of the hub nut caulking device in accordance with the embodiment of the present invention.

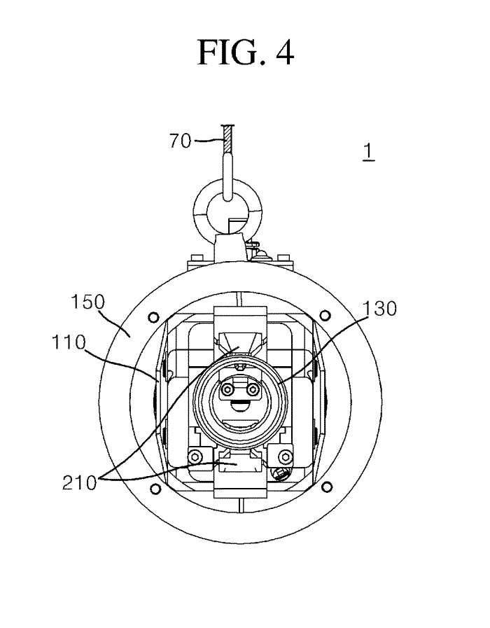

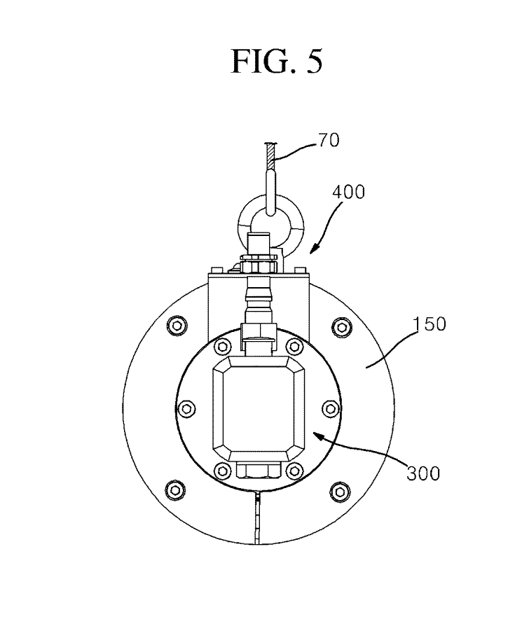

FIG. 4 is a right side view of the hub nut caulking device in accordance with the embodiment of the present invention. FIG. 5 is a left side view of the hub nut caulking device in accordance with the embodiment of the present invention.

Referring to FIGS. 1 to 5, the hub nut caulking device 1 in accordance with the embodiment of the present invention may include a housing member 100, a caulking member 200, a driving member 300, and an output member 400.

The housing member 100 may form the exterior of the hub nut caulking device 1, and the caulking member 200, the driving member 300, and the output member 400 may be coupled to the housing member 100 and supported by the housing member 100. In the present embodiment, the housing member 100 may include a housing part 110 and a caulking guide part 130.

The caulking member 200 may be rotatably coupled to the housing part 110. In the present embodiment, the housing part 110 may have an opening 111 formed at one end thereof such that the caulking member 200 is inserted into the opening 111. The inserted caulking member 200 may be rotatably coupled to the housing member 100 through a rotation pin 230 or the like.

The caulking guide part 130 may be coupled to the end of the housing part 110. As a hub nut 50 is inserted into the caulking guide part 130 so as to adjust the position of the housing part 110 or the caulking member 200 for caulking, a caulking operation can be performed with precision.

In the present embodiment, the hub nut 50 may be coupled to a drive shaft 10 while surrounding an end of the drive shaft 10. Then, a hub 30 may be coupled to the drive shaft 10 through the hub nut 50.

In order to inhibit the hub nut 50 and the drive shaft 10 from being separated from each other, the hub nut caulking device 1 may pressurize and deform the hub nut 50 and then fix the hub nut 50 to a concave shaft groove 11 formed in the drive shaft 10, after the hub nut 50 is coupled to the drive shaft 10.

In the present embodiment, the hub nut 50 may include a hub washer 51, a nut part 53, and a nut ring part 55, which are integrated with each other. The hub washer 51 may be contacted with the hub 30, the nut part 53 may be screwed to the drive shaft 10, and the nut ring part 55 protruding from the nut part 53 may be pressurized and deformed by the caulking part 210 and inserted into the shaft groove 11.

In the present embodiment, the housing member 100 may further include a swivel part 150. The swivel part 150 may rotatably support the housing part 110 such that an operator can rotate the housing part 110 about the central axis of the swivel part 150. The swivel part 150 may include a housing coupling part 151 and a swivel 153.

The housing coupling part 151 may be coupled to the housing part 110. In the present embodiment, the housing coupling part 151 may be formed in a ring shape to surround the housing part 110, and coupled to the housing part 110 through bolting or welding.

The housing part 110 may be rotatably coupled to the swivel 153, and the swivel 153 may be connected to a support wire 70 to rotatably support the housing part 110. In the present embodiment, the swivel 153 may be formed in a ring shape, the housing coupling part 151 may be rotatably coupled to the swivel 153, and a wire connection ring 154 may be coupled to the outer circumferential surface of the swivel 153 so as to support the housing member 100. Thus, the operator can easily move or rotate the housing part 110.

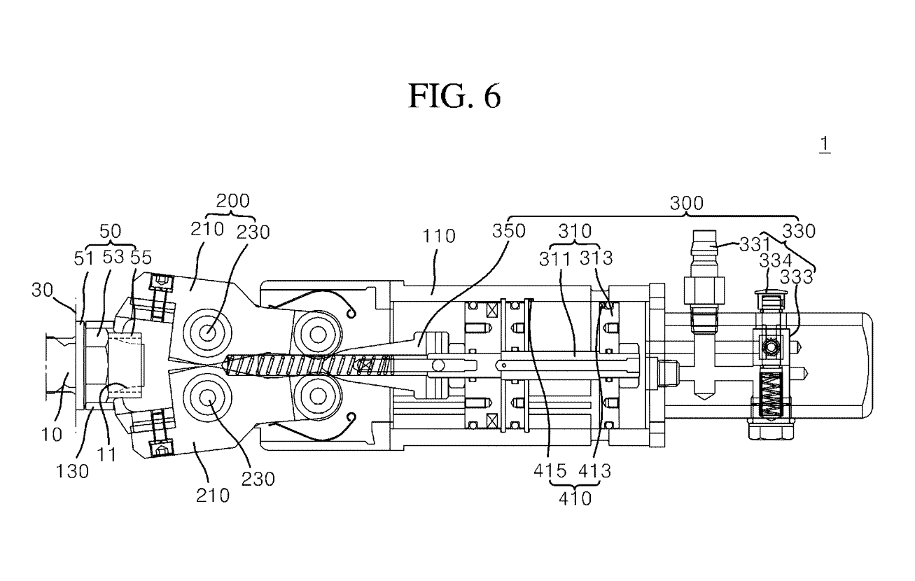

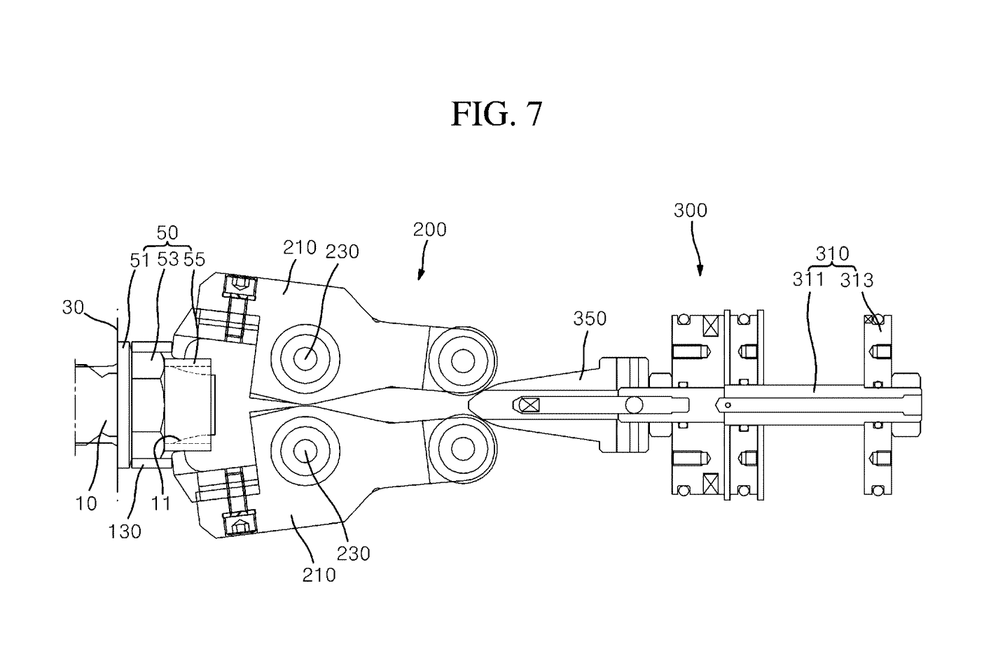

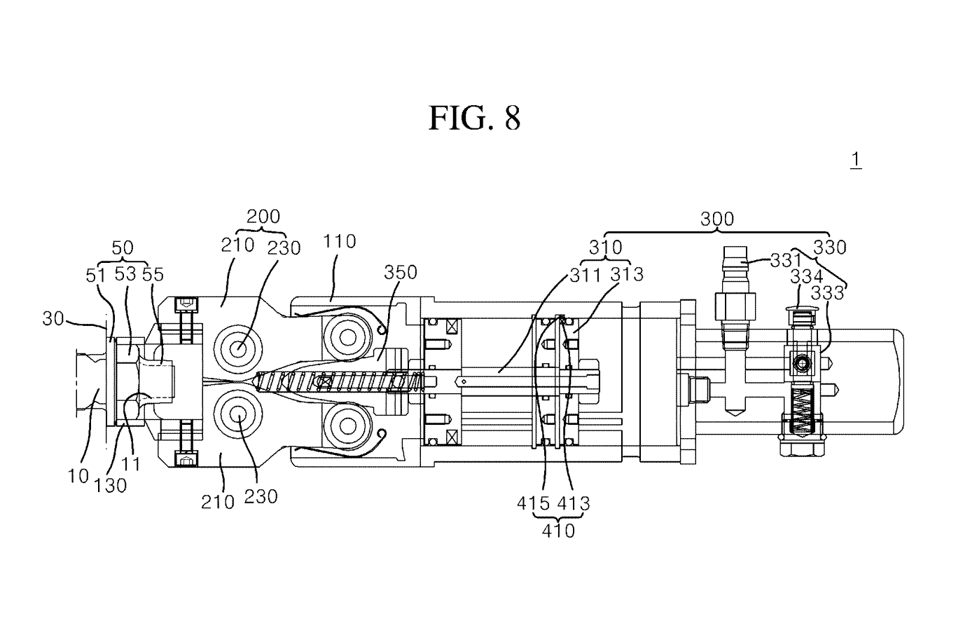

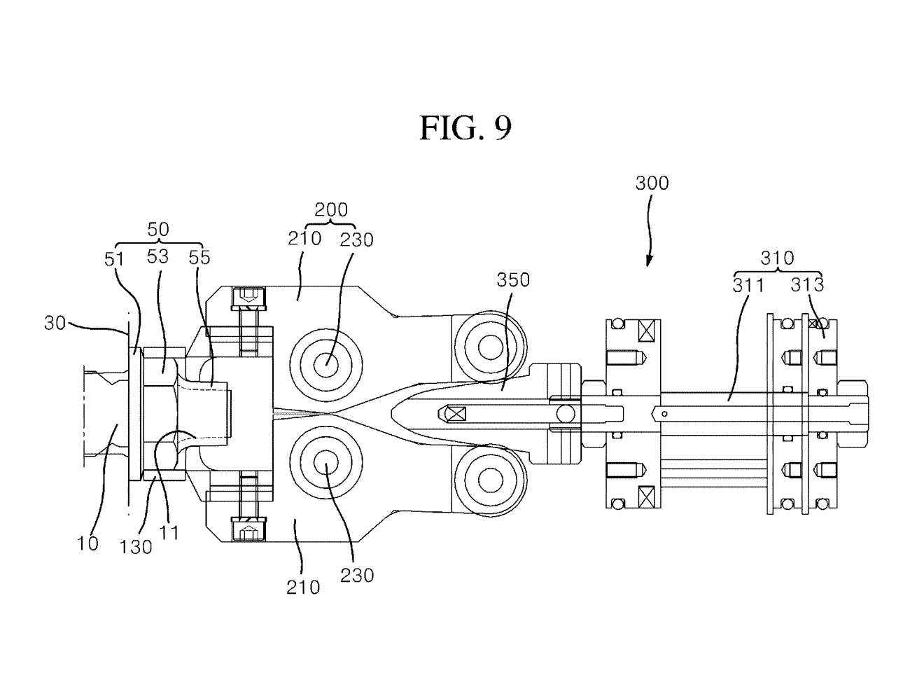

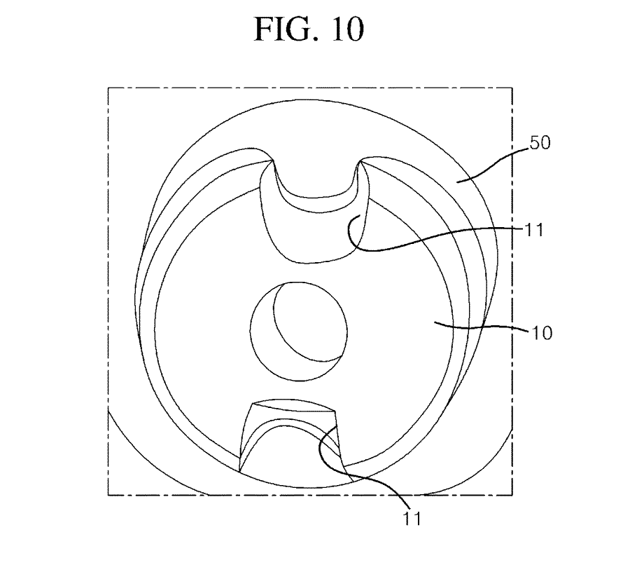

FIG. 6 is a cross-sectional view illustrating a state in which caulking parts are spread in the hub nut caulking device in accordance with the embodiment of the present invention. FIG. 7 is a schematic cross-sectional view of the caulking member and the driving member in FIG. 6. FIG. 8 is a cross-sectional view illustrating a state in which the gap between the caulking parts is narrowed in the hub nut caulking device in accordance with the embodiment of the present invention. FIG. 9 is a schematic cross-sectional view of the caulking member and the driving ember in FIG. 8. FIG. 10 is a diagram illustrating a state in which the hub nut is caulked by the hub nut caulking device in accordance with the embodiment of the present invention.

Referring to FIGS. 6 to 10, the caulking member 200 may include the plurality of caulking parts 210 which are rotatably coupled to the housing member 100 and rotated to pressurize and caulk the hub nut 50.

The driving member 300 may be coupled to the housing member 100 and rotate the caulking parts 210. In the present embodiment, the driving member 300 may include a piston rod part 310, a rod driving part 330, and a wedge part 350.

The piston rod part 310 may be movably installed in the housing member 100. In the present embodiment, the piston rod part 310 may include a piston rod 311 and a piston 313.

The piston rod 311 may be formed in a rod shape which is elongated in the longitudinal direction of the housing member 100, and coupled to the piston 313 so as to be reciprocated with the piston 313 in the housing member 100.

The piston 313 may be formed in a circular plate shape to surround the piston rod 311, and coupled to the piston rod 311 through bolting or welding. In the present embodiment, the piston 313 may be reciprocated in the housing member 100 through hydraulic pressure generated by the driving member 300.

The rod driving part 330 may be coupled to the housing part 110, and move the piston rod part 310 using hydraulic pressure. In the present embodiment, the rod driving part 330 may include a fluid inlet pipe 331 and a control valve 333.

The fluid inlet pipe 331 may be coupled to the housing member 100, and guide fluid such as air, supplied from a fluid storage unit 80, into the housing member 100. In the present embodiment, the flow rate and direction of the fluid supplied to the fluid inlet pipe 331 may be controlled by a main controller 600 which will be described below.

The control valve 333 may control the entry and exit of fluid through the fluid inlet pipe 331. In the present embodiment, the control valve 333 may control a flow of fluid through the fluid inlet pipe 331, and adjust hydraulic pressure applied to the piston 313.

In the present embodiment, when an operator pressurizes the operation switch 334 protruding from the outside of the control valve 333, the control valve 333 may be operated to move fluid into the housing part 110 through the fluid inlet pipe 331. Then, the piston 313 can be moved.

The wedge part 350 may be coupled to an end of the piston rod part 310. As the piston rod part 310 is moved, the wedge part 350 may be forced into the space between the pair of caulking part 210 so as to rotate the caulking parts 210 about the rotation pin 230. Then, the ends of the caulking parts 210 may caulk the hub nut 50.

In the present embodiment, the wedge part 350 may have a cross-sectional area which gradually narrows toward the leading end which is inserted between the caulking parts 210. Thus, as the distance by which the wedge part 350 is inserted between the caulking parts 210 is increased, the extent that the caulking parts 210 are rotated about the rotation pin 230 may be increased.

The output member 400 may be coupled to the housing member 100, and output a sound or light signal to indicate whether the caulking guide part 130 is seated on the hub nut 50 or the driving member 300 is operated. In the present embodiment, the output member 400 may include a movement measurement unit 410 and an output unit 430.

The movement measurement unit 410 may be installed on the housing member 100 or the caulking member 200 so as to measure whether the piston rod 311 was moved a predetermined distance or more. In the present embodiment, the movement measurement unit 410 may include a magnetic force generation unit 413 and a magnetic force measurement unit 415.

The magnetic force generation unit 413 may be coupled to the piston rod part 310 or particularly the piston 313, and generate a magnetic force while being moved with the piston rod part 310. In the present embodiment, the magnetic force generation unit 413 may include a permanent magnet.

The magnetic force measurement unit 415 may be coupled to the housing member 100 or particularly the inner circumferential surface of the housing part 110. The magnetic force measurement unit 415 may measure the magnetic force generated from the magnetic force generation unit 413, in order to determine whether the piston rod 311 was moved a predetermined distance or more.

In the present embodiment, the magnetic force measurement unit 415 may include a magnetic force sensor. The magnetic force measurement unit 415 may be positioned at a predetermined distance from the front of the magnetic force generation unit 413 in a state where the piston rod 311 is retreated, and sense whether the piston rod 311 was moved forward a predetermined distance.

The output unit 430 may output a signal indicating whether the piston rod 311 was moved the predetermined distance or more. In the present embodiment, the output unit 430 may include a lamp 431 capable of controlling a plurality of colors and a light emission interval.

When the magnetic force measurement unit 415 senses the magnetic force generation unit 413, the lamp 431 may emit yellow light which flickers to indicate that the magnetic force generation unit 413 is sensed. On the other hand, when the magnetic force measurement unit 415 does not sense the magnetic force generation unit 413 even at a predetermined time after an operation switch 334 is operated, the lamp 431 may emit red light which flickers to inform the operator that the caulking operation is abnormal.

The output unit 430 may further include a speaker 433 for generating a warning sound. In the present embodiment, when the magnetic force measurement unit 415 senses the magnetic force generation unit 413, the speaker 433 may output a beep at an interval of one second so as to inform the operator that the operation was ended.

Furthermore, when the magnetic force measurement unit 415 does not sense the magnetic force generation unit 413 even at a predetermined time after the operation switch 334 is operated, the output unit 430 may output a beep at an interval of 0.2 second so as to inform the operator that the operation is abnormal.

In the present embodiment, the lamp 431 and the speaker 433 may be operated separately from each other or at the same time, such that the operator can reliably recognize the operation situation of the driving member 300.

In the present embodiment, the output member 400 may further include an output terminal 450. The output terminal 450 may transmit the information on whether the piston rod 311 was moved a predetermined distance or more and the corresponding time information to the main controller 600 connected through a cable or the like, such that the main controller 600 can store and manage the operation history.

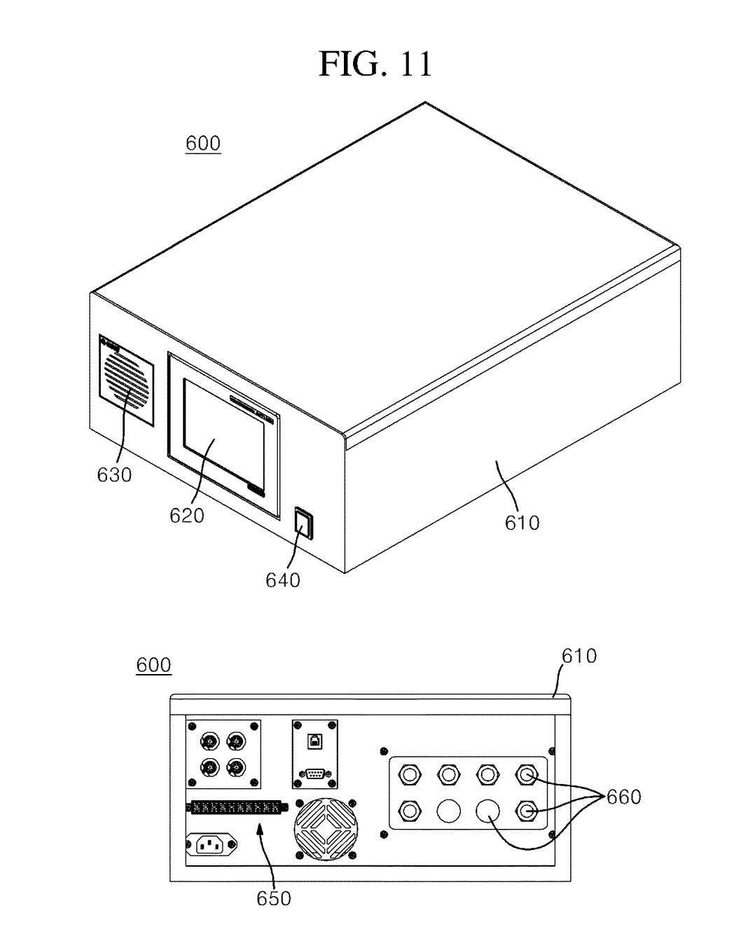

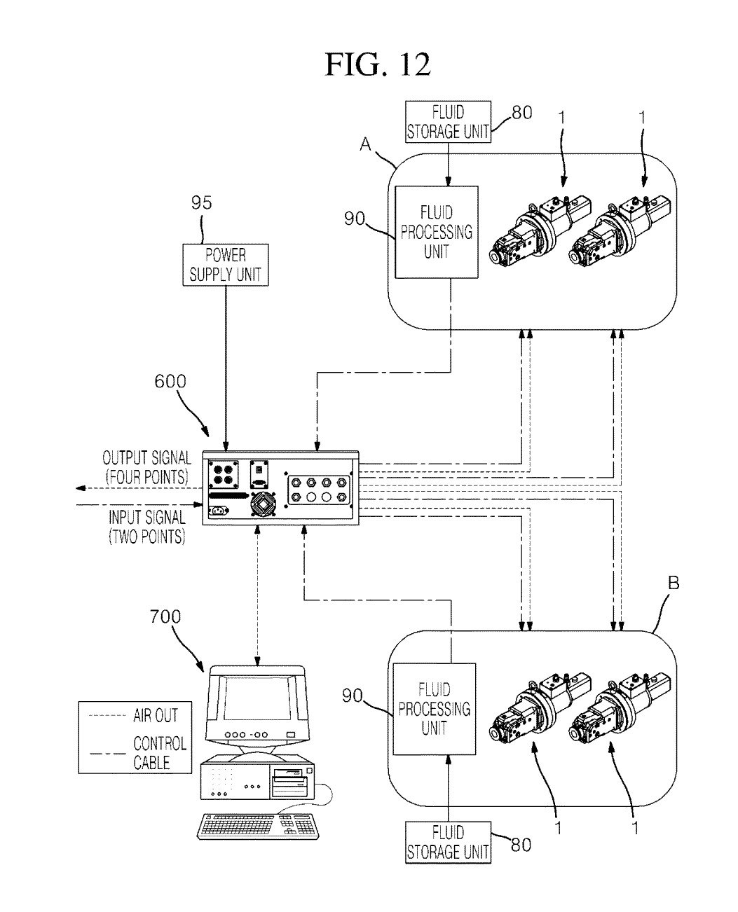

FIG. 11 is a diagram illustrating the main controller in the hub nut caulking device in accordance with the embodiment of the present invention. FIG. 12 is a conceptual view illustrating the main controller and a manufacturing execution system (MES) in the hub nut caulking device in accordance with the embodiment of the present invention.

Referring to FIGS. 11 and 12, the main controller 600 in accordance with the present embodiment may include a main housing 610, a main display unit 620, a main speaker 630, a main switch 640, an input terminal 650, and a fluid entry and exit port 660.

The main display unit 620 may be coupled to the main housing 610, and include a display part which displays the information on the operation situation of the driving member 300, transmitted from the output terminal 450, such that the operator can check the operation situation in real time.

The main speaker 630 may be coupled to the main housing 610, and output the operation situation of the driving member 300 as a sound signal such that the operation can check the operation situation in real time.

The main switch 640 may control power supplied from a power supply unit 95 so as to turn on/off power supplied to the main display unit 620 and the main speaker 630.

The input terminal 650 may be electrically connected to the output terminal 450, receive the operation history of the driving member 300 from the output terminal 450, and transmit the operation history to the MES 700 to store the operation history.

The fluid entry and exit port 660 may be interposed between the fluid storage unit 80 and the fluid inlet pipe 331, and control the pressure of fluid transmitted to the fluid inlet pipe 331. In the present embodiment, the fluid entry and exit port 660 may include a plurality of fluid entry and exit ports to control the pressures of fluids transmitted to the respective fluid inlet pipes 331.

Foreign matters of fluid supplied to the fluid storage unit 80 can be removed, while foreign matters of the fluid supplied to the fluid entry and exit port 660 are removed through a fluid processing part 90.

In the present embodiment, the main controller 600 may be electrically connected to the MES 700 so as to transmit the stored history information, and controlled by the MES 700.

In the present embodiment, the MES 700 may be wirelessly connected to the main controller 600 through a wireless LAN or the like, and transmit and receive signals.

The MES 700 may control the main controller 600 based on the specification of the hub nut 50 and the vehicle type to which the hub nut 60 supplied to the assembly line is applied, and operate the output unit 430.

The hub nut caulking device 1 in accordance with the present embodiment may enable the operator to operate a caulking member 200 among the plurality of caulking members 200 according to the vehicle type and specification, thereby improving the operation convenience. Furthermore, the hub nut caulking device 1 may store the operation history of the corresponding caulking member 200 according to the temporal sequence, such that the operator can check the operation history.

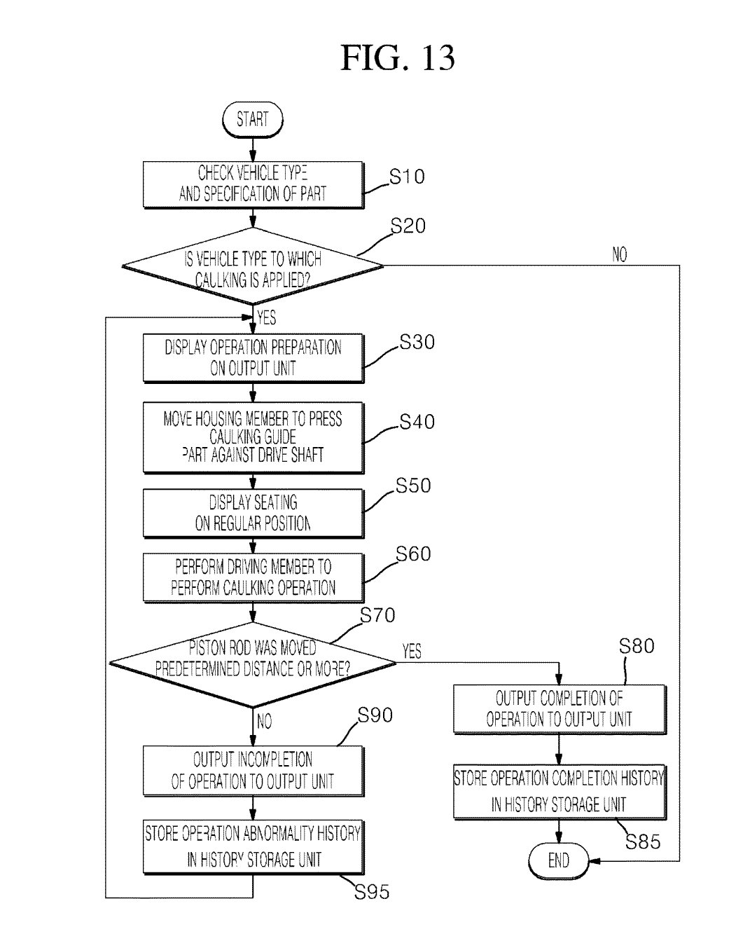

FIG. 13 is a flowchart illustrating a hub nut caulking method in accordance with an embodiment of the present invention. Referring to FIG. 13, the operation and effect of the hub nut caulking method in accordance with the embodiment of the present invention will be described as follows.

When the assembly of the drive shaft 10 and the hub nut 50 of the vehicle is supplied through a conveyer or the like, barcode information may be recognized and transmitted to the MES 700 through wireless communication, at step S10.

The MES 700 may determine the type of a vehicle and the specification of the hub nut 50, based on the barcode information, at step S20. In the case of a vehicle type to which caulking is applied, the MES 700 may control the output unit 430 corresponding to the corresponding hub nut 50 such that the operator can easily distinguish the corresponding device, at step S30.

For example, the MES 700 may control the main controller 600 such that the output unit 430 coupled to the caulking member 200 corresponding to the hub nut 50 introduced to the corresponding assembly line emits flickering yellow light. Then, an operator can recognize the yellow light to avoid a misassembly.

When the operator moves the housing member 100 to insert the hub nut 50 into the caulking guide part 130 at step S40, a seating sensor mounted on the caulking guide part 130 or the housing part 110 may sense the entry of the hub nut 50, and transmit the information on the entry of the hub nut 50 to the output unit 430 to output a predetermined signal, at step S50.

In the present embodiment, the seating sensor may be mounted on the caulking guide part 130 or the housing part 110. When the seating sensor is contacted with the hub nut 50, the seating sensor may sense that the hub nut 50 is inserted into the caulking guide part 130 through a current sensing method which passes a weak current, and transmit the sensing information to the output unit 430.

According to the sensing information of the seating sensor, the output unit 430 may generate a beep for 0.3 second while emitting yellow light which flickers to output a signal indicating that a caulking operation is completely prepared. Then, the operator can recognize the signal and operate the operation switch 334 within a predetermined time.

When the operation switch 334 is not operated during a predetermined time or more after the signal to indicate the caulking preparation is outputted, the output unit 430 may emit yellow light which flickers to inform the operator that the caulking operation is completely prepared. Then, the operator can recognize that the operation time has elapsed.

When the operator operates the operation switch 334, fluid may be introduced into the housing part 110 through the fluid inlet pipe 331, and the piston rod part 310 may be moved forward by the pressure of the introduced fluid, at step S60.

When the piston rod part 310 is moved forward, the wedge part 350 coupled to the leading end of the piston rod 311 may be inserted between the pair of caulking parts 210, and the caulking parts 210 may pressurize and deform the hub nut 50 while being rotated about the rotation pin 230 through the interference with the wedge part 350.

The movement measurement unit 410 may determine whether the caulking operation was reliably performed by the caulking parts 210. In embodiments, when the piston rod part 310 is moved forward by the operation of the operation switch 334, the magnetic force generation unit 413 coupled to the piston rod part 310 may also be moved forward. Then, the magnetic force measurement unit 415 may sense the magnetic force of the magnetic force generation unit 413 and determine whether the caulking parts 210 are operated, at step S70.

When the movement measurement unit 410 measures the completion of the caulking operation, the output unit 430 may output a beep for one second while emitting yellow light which flickers to inform the operator that the caulking operation was completed, at step S80. The information indicating that the caulking operation was completed and the time information may be transmitted to the main controller 600 or the MES 700 through the output terminal 450, at step S85.

When the movement measurement unit 410 does not measure the completion of the caulking operation, the output unit 430 may output a beep for 0.2 second while outputting red light which flickers to inform the operator that the operation is abnormal, at step S90. The information indicating that the caulking operation is abnormal and the time information may be transmitted to the main controller 600 or the MES 700 through the output terminal 450, at step 95.

When the movement measurement unit 410 does not measure the completion of the caulking operation, the MES 700 control the output unit 430 to emit flickering yellow light based on the vehicle type and the specification of the hub nut 50, such that the operator can use a device corresponding to the specification. The operator may perform the caulking process again from the process of moving the housing member 100 and pressing the housing member against the drive shaft 10.

In the present embodiment, since the hub nut caulking device and method can perform caulking at a plurality of positions, the process time can be shortened. Furthermore, the output member 400 may output a sound or light signal to display the specification of the hub nut 50, the information on whether the caulking guide part 130 is seated on the caulking position, and the information on whether the caulking operation was completed, thereby increasing the efficiency of the operation.

Furthermore, the hub nut caulking device and method may transmit the operation history of the caulking process to the main controller 600 or the MES 700 to store the operation history. Thus, the operation history can be systemically managed.

Furthermore, the hub nut caulking device and method may connect the plurality of output terminals 450 and the fluid inlet pipe 331 to the main controller 600. Thus, the configuration of the device can be simplified to reduce the cost, and a plurality of caulking operations can be controlled by one main controller 600.

Although embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. A hub nut caulking device comprising:
a housing member;
a caulking member comprising a plurality of caulking parts which are rotatably coupled to the housing member and configured to rotate to pressurize and caulk the hub nut; and
a driving member coupled to the housing member so as to rotate the caulking parts.

2. The hub nut caulking device of claim 1, wherein the housing member comprises:
a housing part to which the caulking part is rotatably coupled; and
a caulking guide part coupled to an end of the housing part, and contacting with the hub nut so as to adjust the position of the housing part.

3. The hub nut caulking device of claim 2, wherein the housing member further comprises a swivel part configured to rotatably support the housing part.

4. The hub nut caulking device of claim 3, wherein the swivel part comprises:
a housing coupling part coupled to the housing part; and
a swivel to which the housing coupling part is rotatably coupled and which is coupled to a support wire to rotatably support the housing part.

5. The hub nut caulking device of claim 4, wherein the swivel is formed in a ring shape, rotatably coupled to the housing coupling part, and coupled to the support wire through a wire connection ring coupled to the outer circumferential surface thereof.

6. The hub nut caulking device of claim 2, wherein the driving member comprises:
a piston rod part installed to reciprocate in the housing part;
a rod driving part coupled to the housing part, and moving the piston rod part using hydraulic pressure; and
a wedge part coupled to an end of the piston rod part, inserted between the pair of caulking parts according to the movement of the piston rod part, and rotating the caulking part.

7. The hub nut caulking device of claim 6, wherein the wedge part has a cross-sectional area that gradually narrows toward the leading end which is inserted between the caulking parts, and
as the distance by which the wedge part is inserted between the caulking parts is increased, the extent that the caulking parts are rotated is increased.

8. The hub nut caulking device of claim 6, wherein the rod driving part comprises:
a fluid inlet pipe coupled to the housing member and connected to a fluid storage part so as to receive fluid; and
a control valve for controlling entry and exit of fluid through the fluid inlet pipe.

9. The hub nut caulking device of claim 6, further comprising an output member coupled to the housing member and outputting a source or light signal according to the specification of the hub nut or the operation state of the driving member.

10. The hub nut caulking device of claim 9, wherein the output member comprises:
a movement measurement unit installed on the housing member or the caulking member, and measuring whether the piston rod part was moved a predetermined distance or more; and
an output unit outputting the information on whether the piston rod part was moved the predetermined distance or more.

11. The hub nut caulking device of claim 10, wherein the movement measurement unit comprises:
a magnetic force generation unit coupled to the piston rod part and generating a magnetic force; and
a magnetic force measurement unit coupled to the housing member, and measuring the magnetic force generated from the magnetic force generation unit so as to determine whether the piston rod part was moved the predetermined distance or more.

12. The hub nut caulking device of claim 10, wherein the output member further comprises an output terminal for transmitting the information on whether the piston rod part was moved the predetermined distance or more, to a main controller.

13. A hub nut caulking method comprising:
moving a housing part to press a caulking guide part against a drive shaft or a hub nut, the caulking guide part being coupled to the housing part and contacted with the drive shaft or hub nut so as to adjust the position of the housing part; and
operating a driving member coupled to the housing part, and rotating a plurality of caulking parts rotatably coupled to the housing part such that the hub nut is caulked to the drive shaft.

14. The hub nut caulking method of claim 13, further comprising outputting information indicating that the caulking guide part is seated, through an output member coupled to the housing part, when the caulking guide part is pressed against the drive shaft or the hub nut.

15. The hub nut caulking method of claim 14, wherein the driving member comprises a piston rod part installed to reciprocate in the housing part, a rod driving part coupled to the housing part and moving the piston rod part using hydraulic pressure, and a wedge part coupled to an end of the piston rod part, inserted between the pair of caulking parts according to the movement of the piston rod part, and rotating the caulking parts, and
the output member comprises a magnetic force generation unit coupled to the piston rod part and a magnetic force measurement unit coupled to the housing member, determines whether the piston rod part was a predetermined distance or more, and transmits the determination result to a main controller.
